(19) United States
(12) Patent Application Publication
(10) Pub. No.: US 2018/0110313 A1
(43) Pub. Date: Apr. 26, 2018

(54) HAIR DRYER

(71) Applicant: KENFORD INDUSTRIAL COMPANY LTD., Hong Kong (CN)

(72) Inventor: Wai Ho Michael Keong, Hong Kong (CN)

(21) Appl. No.: 15/561,956

(22) PCT Filed: Mar. 24, 2016
(86) PCT No.: PCT/CN2016/077265

§ 371 Date: Sep. 26, 2017

(30) Foreign Application Priority Data
Mar. 26, 2015 (CN) 201520175187.9

(51) Int. Cl. A45D 20/12; H01T 23/00

(52) U.S. Cl. CPC A45D 20/124; A45D 2200/202; H01T 23/00

(57) ABSTRACT

A hair dryer comprises a main body (1), wherein an interior of the main body (1) is formed with an airflow channel, and the airflow channel is formed with an air inlet (11) and an air outlet (12) on the main body (1). The hair dryer further comprises an electrically powered fan (2) provided in the airflow channel and configured to draw external air via the air inlet (11) and then discharge via the air outlet (12), and comprises a rotatable component (3) provided at the air outlet (12) and configured to rotate to change a direction of an airflow formed by rotation of the electrically powered fan (2). A hair dryer airflow direction is changed by the rotatable component (3), thus addressing problems of a non-uniform airflow or ion airflow and a narrow emission surface.

### TECHNICAL FIELD

The present application relates to the field of the hair care equipment, and more particularly to a hair dryer.

### BACKGROUND OF THE INVENTION

Some hair dryers on the market with a built-in ion generator not only can dry or sculpt your hair by blowing it, and can blow the wind containing the wind on the hair care, but also can take care of the hair by blowing the air containing the ions. The hair dryer as disclosed in the patent 201280036596.X, comprises a housing, a fan and a heater disposed within the housing, an ion generator disposed in the housing and upstream of the fan, and a suction filter unit disposed upstream of the fan.

However, the existing airflow or ion flow provided by the hair dryer containing the ion generator is not uniform and the radiation surface is not wide.

### SUMMARY OF THE INVENTION

The purpose of the present application is to propose a hair dryer aiming at the problem that the airflow or ion flow provided by the existing hair dryer containing the ion generator is not uniform and the radiation surface is not wide.

The technical solution of the present application to solve its technical problem is that:

the present application provides a hair dryer, wherein, comprises a main body, an interior of the main body is formed with an airflow channel, and the airflow channel is formed with an air inlet and an air outlet on the main body;

the air dryer further comprises an electrically powered fan provided in the airflow channel and configured to draw external air via the air inlet and then discharge via the air outlet, and comprises a rotatable component provided at the air outlet and configured to rotate to change a direction of an airflow formed by rotation of the electrically powered fan.

The above hair dryer of the present application, further comprises a fixed bracket provided in the airflow channel; the rotatable component comprises an axis provided on the fixed bracket, a rotatable center rotatably mounted on the axis, an outer race concentrically provided with the rotatable center, and a guide vane connecting the rotatable center and the outer race.

The above hair dryer of the present application, a bearing is provided between the rotatable center and the axis; an outer ring of the bearing is fixedly connected with the rotatable center, an inner ring of the bearing is fixedly connected with the axis.

The above hair dryer of the present application, further comprises a heating component provided in the airflow channel and set between the rotatable component and the electrically powered fan, the heating component is configured to heat the air that is drawn into the airflow channel via the electrically powered fan.

The above hair dryer of the present application, further comprises an ion generator provided in the airflow channel; the ion generator comprises an ionization electrode configured to emit ions to the rotatable component; the fixed bracket, the bearing and the rotatable component are all made of conductive materials;

the axis and/or the bearing is connected with a conductive electrode; the polarity of the rotatable component and/or the fixed bracket is opposite to the polarity of the ionization electrode of the ion generator, or the potential of the rotatable component and/or the fixed bracket is lower than the potential of the ionization electrode of the ion generator.

The above hair dryer of the present application, further comprises an ion generator provided in the airflow channel; the ion generator comprises an ionization electrode provided on the rotatable component.

The above hair dryer of the present application, the ionization electrode is provided on the guide vane, the outer race or the rotatable center.

The above hair dryer of the present application, further comprises a lock mechanism provided in the airflow channel and configured to lock the rotatable component.

The above hair dryer of the present application, the lock mechanism comprises a frictional component provided on an outer wall of the outer race, and a lock key movably held against the frictional component and configured to lock the rotatable component.

The above hair dryer of the present application, the lock mechanism comprises a magnetic component provided on an outer wall of the outer race, a lock key movably adsorbed on the magnetic component and configured to lock the rotatable component.

The above hair dryer of the present application, the rotatable component further comprises a deflector provided on an edge of the guide vane and extending in a tangential direction of a rotational surface of the guide vane.

The above hair dryer of the present application, the deflector is made of silica gel.

The present application addresses problems of a non-uniform airflow or ion airflow and a narrow emission surface by changing the hair dryer airflow direction via the rotatable component. In the present application, the fixed bracket, the bearing and the rotatable component are made of conductive materials; the direction of the ion flow is guided by the ionization electrode and the conductive electrode. The present application also achieves the radiation surface of the airflow or the ionized air flow through the deflector. The present application has the advantages of simple structure and strong practicability.

### BRIEF DESCRIPTION OF THE DRAWINGS

The present application will be further described below with reference to the accompanying drawings in which:

FIG. 1 is a schematic view of a hair dryer according to a first embodiment of the present application;

FIG. 2 is a schematic diagram of the rotatable component shown in FIG. 1;

FIG. 3 is an installation diagram of the rotatable component shown in FIG. 1;

FIG. 4 is a schematic view of a hair dryer according to a second embodiment of the present application;

FIG. 5 is a schematic diagram of the rotatable component shown in FIG. 4;

FIG. 6 is an installation diagram of the rotatable component shown in FIG. 4;

FIG. 7 is a first schematic view of the ionization electrode of the ion generator shown in FIG. 4;

FIG. 8 is a second schematic view of the ionization electrode of the ion generator shown in FIG. 4;

FIG. 9 is a third schematic view of the ionization electrode of the ion generator shown in FIG. 4;

FIG. 10 is a first use state reference diagram of a hair dryer according to a third embodiment of the present application;

FIG. 11 is a second use state reference diagram of a hair dryer according to a third embodiment of the present application;

FIG. 12 is a schematic view of another lock mechanism of the present application.

### EMBODIMENTS OF THE INVENTION

The technical problem to be solved by the present application is: the airflow or ion flow provided by the existing hair dryer is not uniform and the radiation surface is not wide. Aiming at the technical problem, the solution of the present application is that: a rotatable component is provided on the air passage of the hair dryer and is rotatable under the action of an air flow which can be changed in the direction of rotation of the rotatable component.

The technical scheme and mechanism of the present application will be described in detail with reference to the drawings and specific examples in order to facilitate the understanding and implementation of the present application by those skilled in the art.

### The First Embodiment

Referring to FIG. 1, FIG. 1 is a schematic view of a hair dryer according to a first embodiment of the present application.

As shown in FIG. 1, the hair dryer comprises a main body 1, an interior of the main body 1 is formed with an airflow channel, and the airflow channel is formed with an air inlet 11 and an air outlet 12 on the main body 1.

The hair dryer further comprises an electrically powered fan 2 provided in the airflow channel; when the electrically powered fan 2 works, the external air is drawn by the air inlet 11, and the external air is discharged by the air outlet 12.

The hair dryer further comprises a rotatable component 3 provided at the air outlet 12; the rotatable component 3 is configured to rotate to change a direction of an airflow formed by rotation of the electrically powered fan 2.

Preferably, in the present embodiment, the rotatable component 3 is rotated by the airflow formed by rotation of the electrically powered fan 2.

While in other embodiments, the rotatable component 3 is driven by a motor.

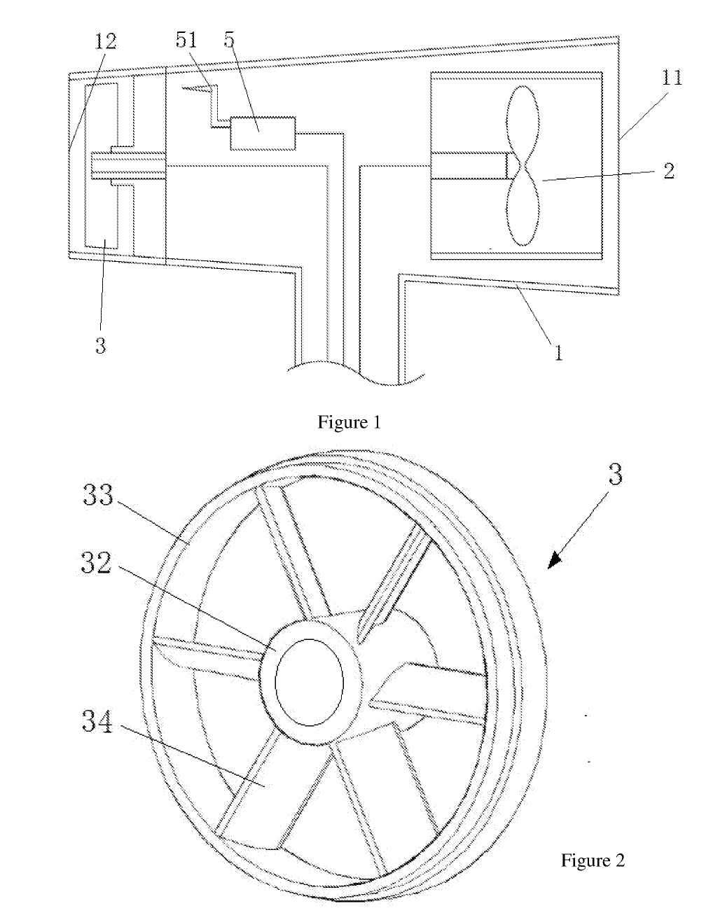

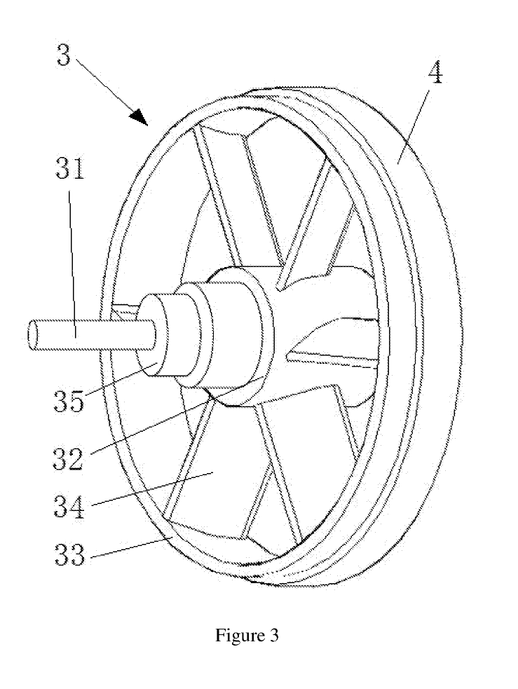

Referring to FIG. 2 and FIG. 3, FIG. 2 is a schematic diagram of the rotatable component 3 shown in FIG. 1; FIG. 3 is an installation diagram of the rotatable component 3 shown in FIG. 1.

As shown in FIG. 2 and FIG. 3, the hair dryer further comprises a fixed bracket 4 provided in the airflow channel The rotatable component 3 is rotatably mounted on the fixed bracket 4. Specifically, the rotatable component 3 comprises an axis 31 provided on the fixed bracket 4, a rotatable center 32 rotatably mounted on the axis 31, an outer race 33 concentrically provided with the rotatable center 32, and a guide vane 34 connecting the rotatable center 32 and the outer race 33.

Here, the guide vane 34 may be one or more for changing the direction of the airflow generated by the rotation of the rotatable component 3.

Further, as shown in FIG. 3, a bearing 35 is provided between the rotatable center 32 and the axis 31. Specifically, an outer ring of the bearing 35 is fixedly connected with the rotatable center 32, and an inner ring of the bearing 35 is fixedly connected with the axis 31. The present embodiment reduces the friction between the rotatable center 32 and the axis 31 by the bearing 35.

Further, the hair dryer further comprises a heating component (not shown) provided in the airflow channel and set between the rotatable component 3 and the electrically powered fan 2. The heating component is configured to heat the air that is drawn into the airflow channel via the electrically powered fan 2.

As shown in FIG. 1, the hair dryer further comprises an ion generator 5 provided in the airflow channel and for generating ions; the ion generator 5 comprises an ionization electrode 51, and emits ions to the rotatable component 3 via the ionization electrode 51. In order to allow the ions to flow, in the present embodiment, the fixed bracket 4, the bearing 35 and the rotatable component 3 are all made of conductive materials.

Simultaneously, the axis 31 and/or the bearing 35 is connected with a conductive electrode (not shown), to change the polarity and/or the potential of the rotatable component 3 and/or the fixed bracket 4. In general, the polarity of the rotatable component 3 and/or the fixed bracket 4 is opposite to the polarity of the ion generator 5, or the potential of the rotatable component 3 and/or the fixed bracket 4 is lower than the potential of the ionization electrode 51 of the ion generator.

### The Second Embodiment

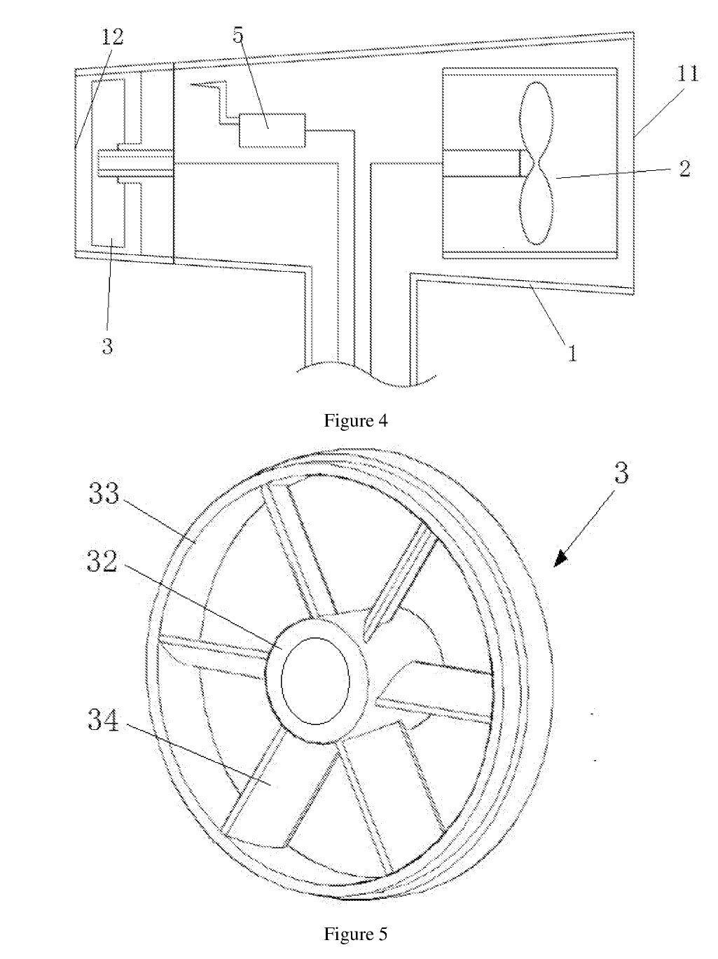

Referring to FIG. 4, FIG. 4 is a schematic view of a hair dryer according to a second embodiment of the present application.

As shown in FIG. 4, the hair dryer comprises a main body 1, an interior of the main body 1 is formed with an airflow channel, and the airflow channel is formed with an air inlet 11 and an air outlet 12 on the main body 1.

The hair dryer further comprises an electrically powered fan 2 provided in the airflow channel; when the electrically powered fan 2 works, the external air is drawn by the air inlet 11, and the external air is discharged by the air outlet 12.

The hair dryer further comprises a rotatable component 3 provided at the air outlet 12; the rotatable component 3 is configured to rotate to change a direction of an airflow formed by rotation of the electrically powered fan 2.

Preferably, in the present embodiment, the rotatable component 3 is rotated by the airflow formed by rotation of the electrically powered fan 2.

While in other embodiments, the rotatable component 3 is driven by a motor.

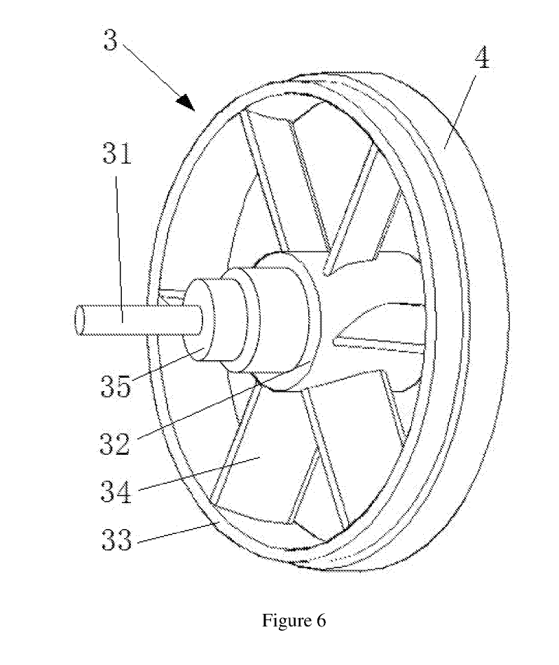

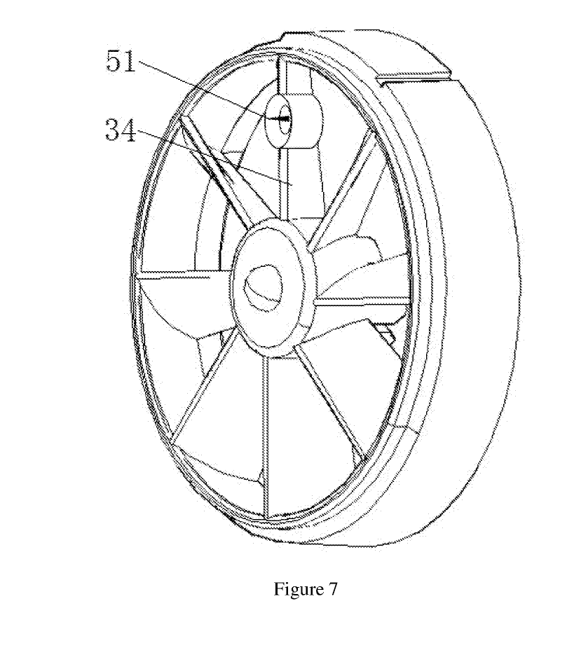

Referring to FIG. 5 and FIG. 6, FIG. 5 is a schematic diagram of the rotatable component 3 shown in FIG. 4; FIG. 6 is an installation diagram of the rotatable component 3 shown in FIG. 4.

As shown in FIG. 5 and FIG. 6, the hair dryer further comprises a fixed bracket 4 provided in the airflow channel The rotatable component 3 is rotatably mounted on the fixed bracket 4. Specifically, the rotatable component 3 comprises an axis 31 provided on the fixed bracket 4, a rotatable center 32 rotatably mounted on the axis 31, an outer race 33 concentrically provided with the rotatable center 32, and a guide vane 34 connecting the rotatable center 32 and the outer race 33.

Here, the guide vane 34 may be one or more for changing the direction of the airflow generated by the rotation of the rotatable component 3.

Further, as shown in FIG. 6, a bearing 35 is provided between the rotatable center 32 and the axis 31. Specifically, an outer ring of the bearing 35 is fixedly connected with the rotatable center 32, and an inner ring of the bearing 35 is fixedly connected with the axis 31. The present embodiment reduces the friction between the rotatable center 32 and the axis 31 by the bearing 35.

Further, the hair dryer further comprises a heating component (not shown) provided in the airflow channel and set between the rotatable component 3 and the electrically powered fan 2. The heating component is configured to heat the air that is drawn into the airflow channel via the electrically powered fan 2.

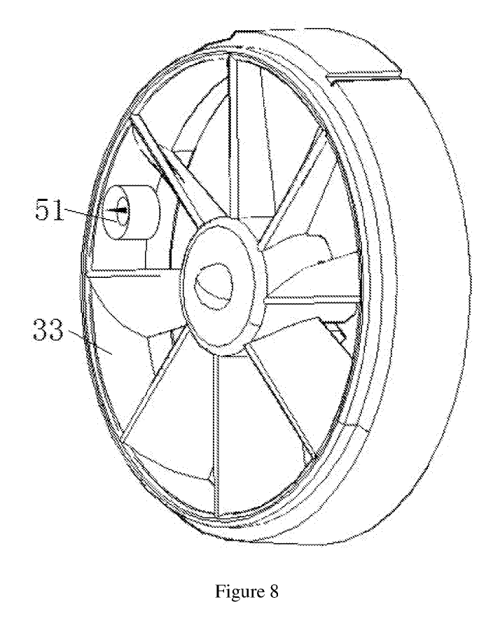

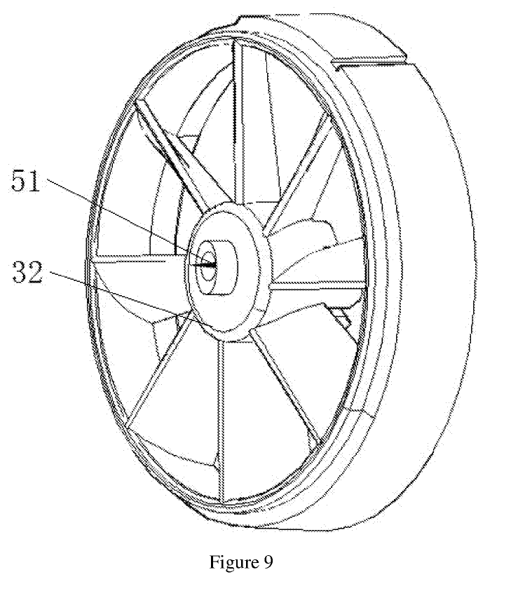

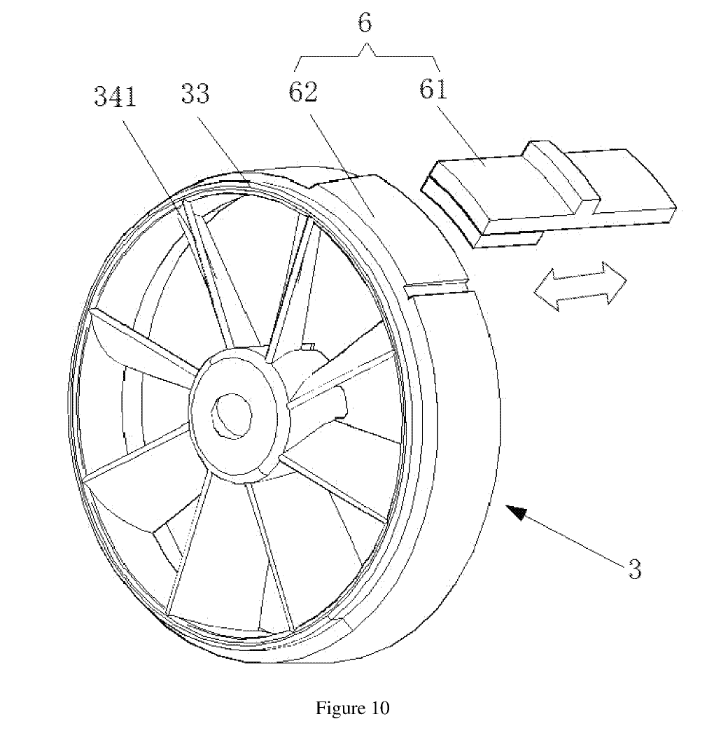

Referring to FIG. 4, FIG. 7-FIG. 9, FIG. 7 is a first schematic view of the ionization electrode 51 of the ion generator shown in FIG. 4; FIG. 8 is a second schematic view of the ionization electrode 51 of the ion generator shown in FIG. 4; FIG. 9 is a third schematic view of the ionization electrode 51 of the ion generator shown in FIG. 4.

As shown in FIG. 4, the hair dryer further comprises an ion generator 5 provided in the airflow channel and for generating ions; the ion generator 5 comprises an ionization electrode 51, and the ionization electrode 51 is provided on the rotatable component 3.

As shown in FIG. 7, the ionization electrode 51 can be provided on the guide vane 34; as shown in FIG. 8, the ionization electrode 51 can also be provided on the outer race 33; as shown in FIG. 9, the ionization electrode 51 can also be provided on the provided rotatable center 32.

### The Third Embodiment

The third embodiment differs from the first embodiment or the second embodiment in that, the hair dryer further comprises a lock mechanism 6.

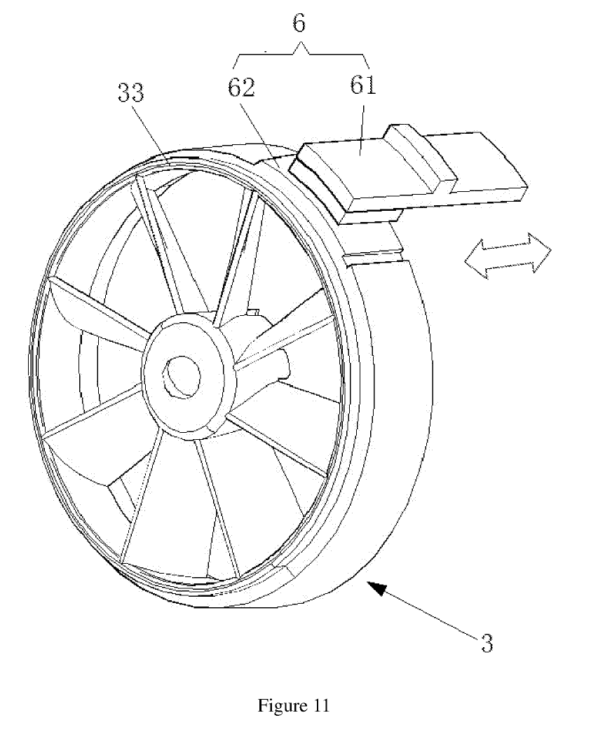

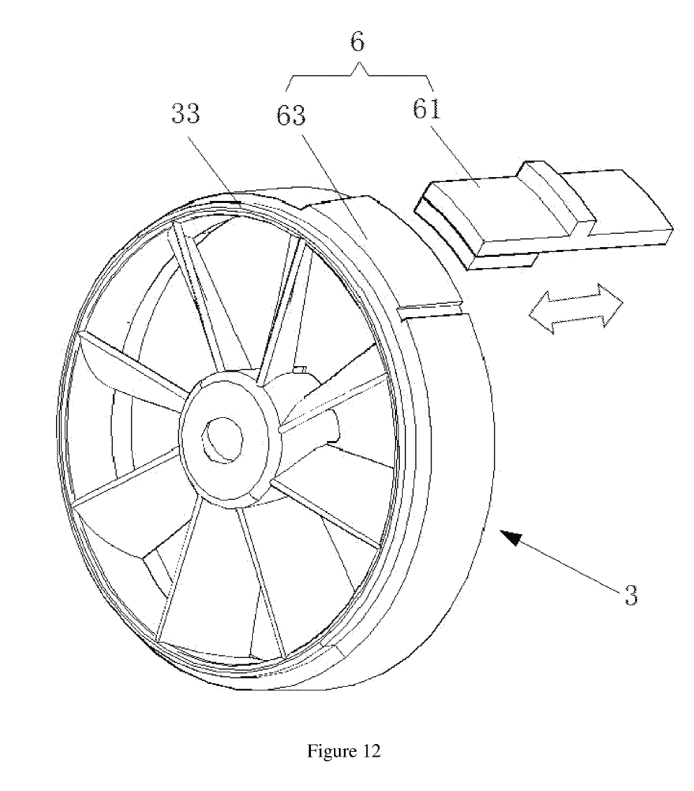

Referring to FIG. 10 and FIG. 11, FIG. 10 is a first use state reference diagram of a hair dryer according to a third embodiment of the present application; FIG. 11 is a second use state reference diagram of a hair dryer according to a third embodiment of the present application.

As shown in FIG. 10, the hair dryer further comprises a lock mechanism 6 provided in the airflow channel and configured to lock the rotatable component 3.

As shown in FIG. 10, lock mechanism 6 is in the unlocked position, and at this time, the rotatable member 3 can be rotated; as shown in FIG. 11, lock mechanism 6 is in the locked position, and at this time, the rotatable member 3 is locked and cannot be rotated.

In the present embodiment, the lock mechanism 6 comprises a frictional component 62 provided on an outer wall of the outer race 33 and a lock key 61 movably held against the frictional component and configured to lock the rotatable component 3.

Preferably, frictional component 62 may be a low hardness member such as a silicone article or the like. The extending direction of the frictional component 62 is parallel to the axial direction of the outer race 33.

In other embodiments, as shown in FIG. 12, the lock mechanism 6 comprises a magnetic component 63 provided on the outer wall of the outer race 33 and a lock key 61 movably adsorbed on the magnetic component 63 and configured to lock the rotatable component 3.

As shown in FIG. 10, rotatable component 3 further comprises a deflector 341 provided on an edge of the guide vane 34 and extending in a tangential direction of a rotational surface of the guide vane 34; the deflector 341 is made of silica gel.

The present application addresses problems of a non-uniform airflow or ion airflow and a narrow emission surface by changing the hair dryer airflow direction via the rotatable component. In the present application, the fixed bracket, the bearing and the rotatable component are made of conductive materials, the direction of the ion flow is guided by the ionization electrode and the conductive electrode. The present application also achieves the radiation surface of the airflow or the ionized air flow through the deflector. The present application has the advantages of simple structure and strong practicability.

It is to be understood that one of ordinary skill in the art may be modified or modified in accordance with the above description and that all such modifications and alterations are within the scope of the appended claims of the present application.

1. A hair dryer, comprising:
a main body (1), an interior of the main body (1) is formed with an airflow channel, and the airflow channel is formed with an air inlet (11) and an air outlet (12) on the main body (1);
an electrically powered fan (2) provided in the airflow channel and configured to draw external air via the air inlet (11) and then discharge via the air outlet (12), and a rotatable component (3) provided at the air outlet (12) and configured to rotate to change a direction of an airflow formed by rotation of the electrically powered fan (2).

2. The hair dryer according to claim 1, further comprising: a fixed bracket (4) provided in the airflow channel; the rotatable component (3) comprises an axis (31) provided on the fixed bracket (4), a rotatable center (32) rotatably mounted on the axis (31), an outer race (33) concentrically provided with the rotatable center (32), and a guide vane (34) connecting the rotatable center (32) and the outer race (33).

3. The hair dryer according to claim 2, wherein, a bearing (35) is provided between the rotatable center (32) and the axis (31); an outer ring of the bearing (35) is fixedly connected with the rotatable center (32), an inner ring of the bearing (35) is fixedly connected with the axis (31).

4. The hair dryer according to claim 3, further comprising a heating component provided in the airflow channel and set between the rotatable component (3) and the electrically powered fan (2), the heating component is configured to heat the air that is drawn into the airflow channel via the electrically powered fan (2).

5. The hair dryer according to claim 4, further comprising an ion generator (5) provided in the airflow channel;
the ion generator (5) comprises an ionization electrode (51) configured to emit ions to the rotatable component (3); the fixed bracket (4), the bearing (35) and the rotatable component (3) are all made of conductive materials;
the axis (31) and/or the bearing (35) is connected with a conductive electrode; the polarity of the rotatable component (3) and/or the fixed bracket (4) is opposite to the polarity of the ionization electrode (51) of the ion generator (5), or the potential of the rotatable component (3) and/or the fixed bracket (4) is lower than the potential of the ionization electrode (51) of the ion generator (5).

6. The hair dryer according to claim 4, further comprising an ion generator (5) provided in the airflow channel; the ion generator (5) comprises an ionization electrode (51) provided on the rotatable component (3).

7. The hair dryer according to claim 6, wherein, the ionization electrode (51) is provided on the guide vane (34), the outer race (33) or the rotatable center (32).

8. The hair dryer according to claim 2, further comprising a lock mechanism (6) provided in the airflow channel and configured to lock the rotatable component (3).

9. The hair dryer according to claim 8, wherein, the lock mechanism (6) comprises a frictional component (62) provided on an outer wall of the outer race (33), and a lock key (61) movably held against the frictional component (62) and configured to lock the rotatable component (3).

10. The hair dryer according to claim 8, wherein, the lock mechanism (6) comprises a magnetic component (63) provided on an outer wall of the outer race (33), a lock key (61) movably adsorbed on the magnetic component (63) and configured to lock the rotatable component (3).

11. The hair dryer according to claim 2, wherein, the rotatable component (3) further comprises a deflector (341) provided on an edge of the guide vane (34) and extending in a tangential direction of a rotational surface of the guide vane (34).

12. The hair dryer according to claim 11, wherein, the deflector (341) is made of silica gel.

13. The hair dryer according to claim 2, further comprising a heating component provided in the airflow channel and set between the rotatable component (3) and the electrically powered fan (2), the heating component is configured to heat the air that is drawn into the airflow channel via the electrically powered fan (2).

14. The hair dryer according to claim 3, further comprising a lock mechanism (6) provided in the airflow channel and configured to lock the rotatable component (3).

15. The hair dryer according to claim 14, wherein, the lock mechanism (6) comprises a frictional component (62) provided on an outer wall of the outer race (33), and a lock key (61) movably held against the frictional component (62) and configured to lock the rotatable component (3).

16. The hair dryer according to claim 14, wherein, the lock mechanism (6) comprises a magnetic component (63) provided on an outer wall of the outer race (33), a lock key (61) movably adsorbed on the magnetic component (63) and configured to lock the rotatable component (3).

17. The hair dryer according to claim 3, wherein, the rotatable component (3) further comprises a deflector (341) provided on an edge of the guide vane (34) and extending in a tangential direction of a rotational surface of the guide vane (34).

18. The hair dryer according to claim 17, wherein, the deflector (341) is made of silica gel.
